(19) United States
(12) Patent Application Publication
(10) Pub. No.: US 2016/0234694 A1
(43) Pub. Date: Aug. 11, 2016

(54) COMMUNICATION CONTROL METHOD, BASE STATION, AND USER TERMINAL

(71) Applicant: KYOCERA CORPORATION, Kyoto (JP)

(72) Inventors: Chiharu YAMAZAKI, Ota-ku, Tokyo (JP); Masato FUJISHIRO, Yokohama-shi, Kanagawa (JP)

(73) Assignee: KYOCERA CORPORATION, Kyoto (JP)

(21) Appl. No.: 15/024,700

(22) PCT Filed: Sep. 24, 2014
(86) PCT No.: PCT/JP2014/075322

§ 371 Date: Mar. 24, 2016

(30) Foreign Application Priority Data
Sep. 26, 2013 (JP) 2013-199876

(51) Int. Cl. H04W 16/28; H04B 7/04; H04B 7/02

(52) U.S. Cl. CPC H04W 16/28; H04B 7/024; H04B 7/0452

(57) ABSTRACT

A communication control method comprises a step A of feeding back for a plurality of number of times, by a UE 100-1 subject to null steering by a eNB 200-2, null-steering control information for controlling the null steering; and a step B of selecting, by the eNB 200-2, through a matching process in which the null-steering control information fed back from the UE 100-1 is checked with beamforming control information fed back from UEs 100-2, a pair UE that forms a pair with the UE 100-1 from among the UEs 100-2. In the step B, the eNB 200-2 applies, in addition to latest null-steering control information fed back this time from the UE 100-1, past null-steering control information fed back prior to a last time from the UE 100-1 to the matching process.

### TECHNICAL FIELD

The present invention relates to a communication control method, a base station, and a user terminal used in a mobile communication system that supports downlink multi-antenna transmission

### BACKGROUND ART

An LTE (Long Term Evolution) system of which the specifications are designed in 3GPP (3rd Generation Partnership Project), which is a project aiming to standardize a mobile communication system, supports downlink multi-antenna transmission (see Non Patent Literature 1). For example, a base station directs a beam to one user terminal (beamforming) and directs a null to another user terminal (null steering).

Further, a mode of the downlink multi-antenna transmission includes CB (Coordinated Beamforming)-CoMP (Coordinated Multi Point).

### CITATION LIST

### Non Patent Literature

[NPL 1] 3GPP Technical Specification “TS 36.300 V11.6.0” July, 2013

### SUMMARY OF INVENTION

In the CB-CoMP, a base station that manages a cell receives beamforming control information fed back from each of a plurality of terminals subject to beamforming connected with the cell of the base station, and null-steering control information fed back from a terminal subject to null steering connected with a neighboring cell. Then, the base station selects, as a pair terminal that forms a pair with the terminal subject to null steering, a terminal subject to beamforming that feeds back the beamforming control information that matches the null-steering control information.

However, when there is no terminal subject to beamforming that feeds back beamforming control information that matches null-steering control information, a base station is not capable of selecting a pair terminal. In this case, there is a problem in that it is not possible to effectively utilize the downlink multi-antenna transmission.

Therefore, an object of the present invention is to provide a communication control method, a base station, and a user terminal, with which it is possible to effectively utilize the downlink multi-antenna transmission.

A communication control method according to a first aspect is used in a mobile communication system that supports downlink multi-antenna transmission. The communication control method comprises a step A of feeding back for a plurality of number of times, by a user terminal subject to null steering by a base station, null-steering control information for controlling the null steering; and a step B of selecting, by the base station, through a matching process in which the null-steering control information fed back from the user terminal is checked with beamforming control information fed back from other user terminals, a pair terminal that forms a pair with the user terminal from among the other user terminals. The base station manages a history of past null-steering control information fed back prior to a last time from the user terminal. In the step B, the base station applies, in addition to latest null-steering control information fed back this time from the user terminal, the past null-steering control information to the matching process.

A base station according to a second aspect is used in a mobile communication system that supports downlink multi-antenna transmission. The base station comprises a receiver configured to receive null-steering control information fed back for a plurality of number of times from a user terminal subject to null steering by the base station; and a controller configured to select, through a matching process in which the null-steering control information fed back from the user terminal is checked with beamforming control information fed back from other user terminals, a pair terminal that forms a pair with the user terminal from among the other user terminals. The controller manages a history of past null-steering control information fed back prior to a last time from the user terminal. The controller applies, in addition to latest null-steering control information fed back this time from the user terminal, the past null-steering control information to the matching process.

A user terminal according to a third aspect is a user terminal subject to null steering by a base station, in a mobile communication system that supports downlink multi-antenna transmission. The user terminal comprises a controller configured to feed back for a plurality of number of times null-steering control information for controlling the null steering. The controller adds additional information associated with the priority order of the null-steering control information to be fed back, to the null-steering control information to be fed back.

### BRIEF DESCRIPTION OF DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface according to the embodiment.

FIG. 5 is a configuration diagram of a radio frame according to the embodiment.

FIG. 6 is a diagram (part 1) for describing CB-CoMP according to the embodiment.

FIG. 7 is a diagram (part 2) for describing CB-CoMP according to the embodiment.

FIG. 8 is a diagram for describing an operation pattern 1 according to the embodiment.

FIG. 9 is a diagram for describing an operation pattern 2 according to the embodiment.

FIG. 10 is a diagram for describing an operation pattern 3 according to the embodiment.

FIG. 11 is a diagram for describing MU-MIMO according to a modification of the embodiment (part 1).

FIG. 12 is a diagram for describing the MU-MIMO according to the modification of the embodiment (part 2).

### DESCRIPTION OF EMBODIMENTS

### Overview of Embodiments

A communication control method according to embodiments is used in a mobile communication system that supports downlink multi-antenna transmission. The communication control method comprises a step A of feeding back for a plurality of number of times, by a user terminal subject to null steering by a base station, null-steering control information for controlling the null steering; and a step B of selecting, by the base station, through a matching process in which the null-steering control information fed back from the user terminal is checked with beamforming control information fed back from other user terminals, a pair terminal that forms a pair with the user terminal from among the other user terminals. The base station manages a history of past null-steering control information fed back prior to a last time from the user terminal. In the step B, the base station applies, in addition to latest null-steering control information fed back this time from the user terminal, the past null-steering control information to the matching process.

In the embodiments, in the step B, the base station selects, as the pair terminal, the one of the other user terminals that feeds back the beamforming control information that matches either one of the latest null-steering control information or the past null-steering control information. The communication control method further comprises a step C of performing, by the base station, a beamforming to the pair terminal and the null steering to the user terminal, on the basis of the matched beamforming control information.

In operation pattern 1 of the embodiments, in the step A, the user terminal feeds back null-steering control information having a highest priority order, from among a plurality of pieces of null-steering control information having a priority order set on the basis of a radio situation of the user terminal. In the step B, the base station sets, as a priority order of the beamforming control information applied to the matching process, a relatively high priority order to the beamforming control information that is relatively new.

In operation pattern 2 and 3 of the embodiments, in the step A, the user terminal derives a plurality of pieces of null-steering control information having a priority order set on the basis of a radio situation of the user terminal. When the null-steering control information having a highest priority order is different between during a last feedback and during a current feedback, the user terminal feeds back the null-steering control information having the highest priority order. When the null-steering control information having the highest priority order is the same between during the last feedback and during the current feedback, the user terminal feeds back null-steering control information having a second highest priority order.

In operation pattern 2 and 3 of the embodiments, in the step A, when the null-steering control information having the highest priority order and the null-steering control information having the second highest priority order are the same between during the last feedback and during the current feedback, the user terminal feeds back null-steering control information having a third highest priority order.

In operation pattern 2 and 3 of the embodiments, in the step A, the user terminal adds additional information associated with the priority order of null-steering control information to be fed back, to the null-steering control information to be fed back.

In operation pattern 2 of the embodiments, the additional information is information indicating the priority order of the null-steering control information to be fed back.

In operation pattern of the embodiments, the additional information is information indicating whether or not the history managed by the base station should be deleted.

In operation pattern 2 and 3 of the embodiments, in the step B, when the latest null-steering control information is the null-steering control information having the highest priority order or when it is indicated that the history should be deleted, as the priority order of the beamforming control information applied to the matching process, the base station sets the latest null-steering control information to the highest priority order, and deletes the history.

In operation pattern 2 and 3 of the embodiments, in the step B, when the latest null-steering control information is the null-steering control information having the highest priority order, as the priority order of the beamforming control information applied to the matching process, the base station sets the latest null-steering control information to the highest priority order and moves down by one the priority order of the past null-steering control information included in the history.

In operation pattern 2 of the embodiments, in the step B, when the latest null-steering control information is the null-steering control information having the second highest priority order, as the priority order of the beamforming control information applied to the matching process, the base station sets the past null-steering control information having the newest highest priority order of the history, to the highest priority order, sets the latest null-steering control information to the second highest priority order, and deletes the past null-steering control information having a second priority order or lower included in the history.

Alternatively, in operation pattern 2 of the embodiments, in the step B, when the latest null-steering control information is the null-steering control information having the second highest priority order, as the priority order of the beamforming control information applied to the matching process, the base station sets the past null-steering control information having the newest highest priority order of the history, to the highest priority order, sets the latest null-steering control information to the second highest priority order, and moves down by one the priority order of the past null-steering control information having a second priority order or lower included in the history.

In operation pattern 3 of the embodiments, in the step B, when it is indicated that the history should not be deleted, as the priority order of the beamforming control information applied to the matching process, the base station sets the past null-steering control information having the newest highest priority order of the history, to the highest priority order, and sets the past null-steering control information fed back subsequent to the past null-steering control information having the newest highest priority order, to the second highest priority order.

A base station according to the embodiments is used in a mobile communication system that supports downlink multi-antenna transmission. The base station comprises a receiver configured to receive null-steering control information fed back for a plurality of number of times from a user terminal subject to null steering by the base station; and a controller configured to select, through a matching process in which the null-steering control information fed back from the user terminal is checked with beamforming control information fed back from other user terminals, a pair terminal that forms a pair with the user terminal from among the other user terminals. The controller manages a history of past null-steering control information fed back prior to a last time from the user terminal. The controller applies, in addition to latest null-steering control information fed back this time from the user terminal, the past null-steering control information to the matching process.

A user terminal according to the embodiments is a user terminal subject to null steering by a base station, in a mobile communication system that supports downlink multi-antenna transmission. The user terminal comprises a controller configured to feed back for a plurality of number of times null-steering control information for controlling the null steering. The controller adds additional information associated with the priority order of the null-steering control information to be fed back, to the null-steering control information to be fed back.

### Embodiments

An embodiment of applying the present invention to the LTE system will be described below.

(System Configuration)

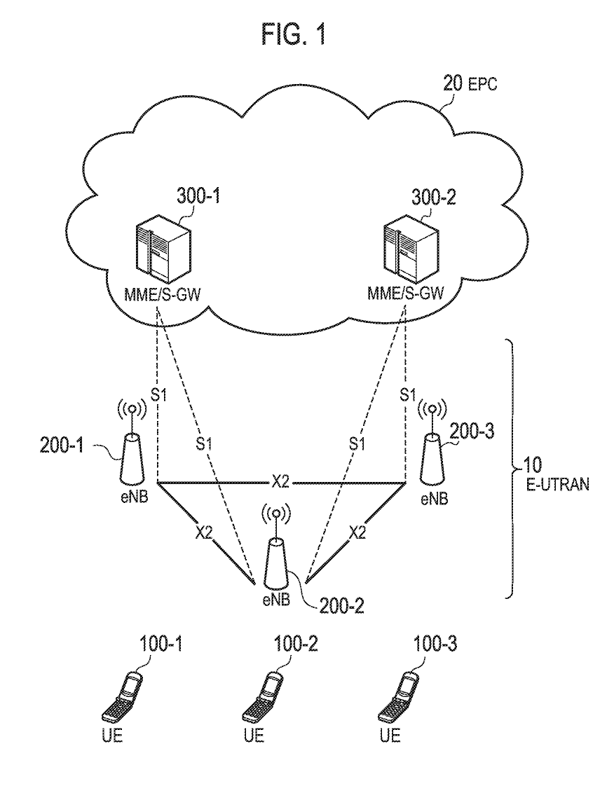

FIG. 1 is a configuration diagram of an LTE system according to an embodiment. As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. A network of the LTE system is configured by the E-UTRAN 10 and the EPC 200. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface.

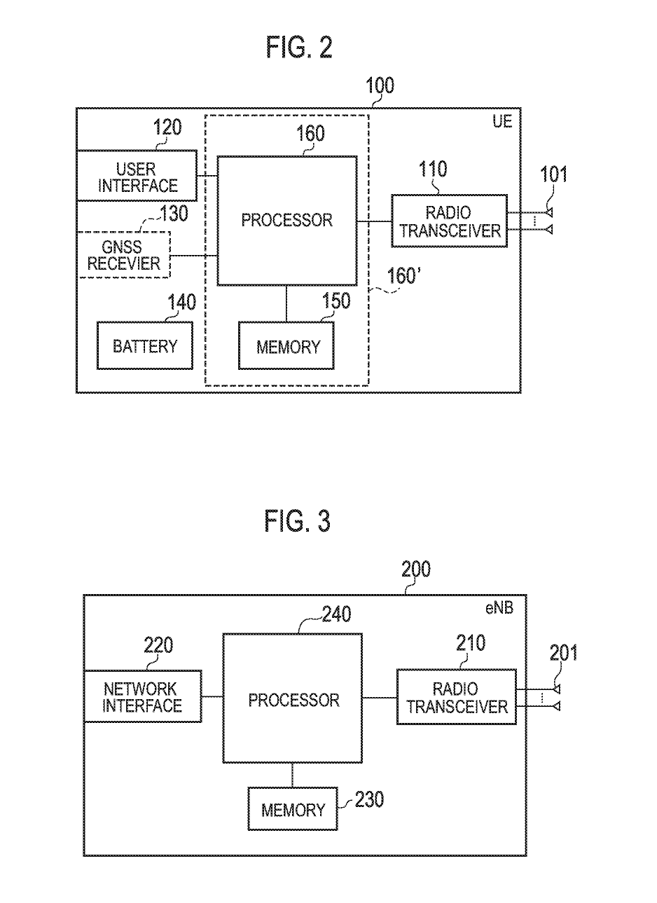

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The memory 230 and the processor 240 constitute a controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

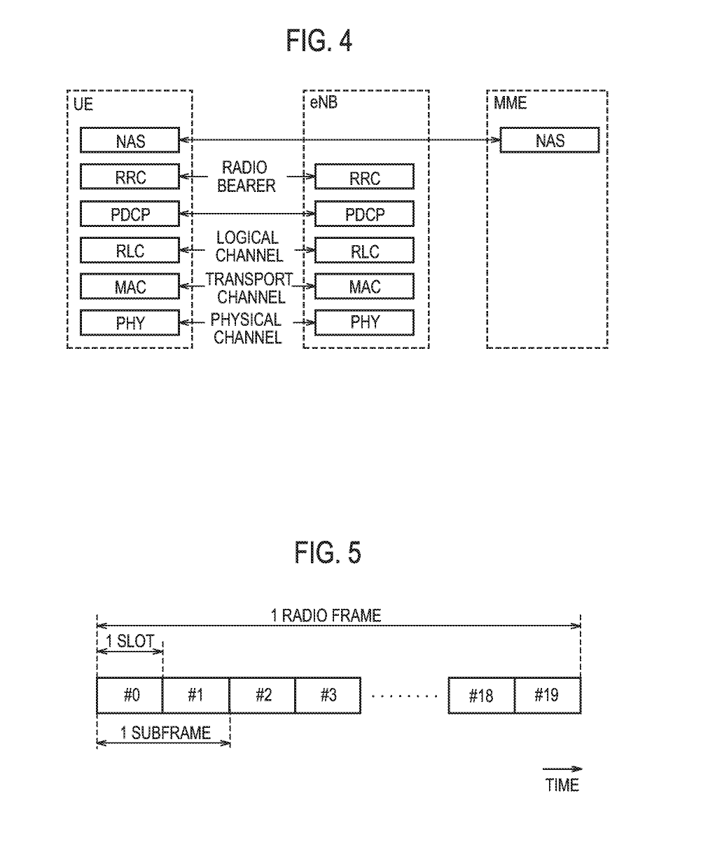

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. The PHY layer of the eNB 200 applies a precoder matrix (transmission antenna weight) and a rank (number of signal sequences) to perform downlink multi-antenna transmission. The downlink multi-antenna transmission according to the embodiment will be described later. Between the PHY layer of the UE 100 and the PHY layer of the eNB 200, use data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control message (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in a connected state (an RRC connected state), otherwise the UE 100 is in an idle state (an RRC idle state).

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplex Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Among radio resources assigned to the UE 100, a frequency resource can be specified by a resource block and a time resource can be specified by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. Furthermore, the central portion in the frequency direction of each subframe is a region available as a physical uplink shared channel (PUSCH) for mainly transmitting user data.

(CB-CoMP)

The LTE system according to the embodiment supports CB-CoMP which is a mode of the downlink multi-antenna transmission. In the CB-CoMP, a plurality of eNBs 200 work together to perform the beamforming and the null steering.

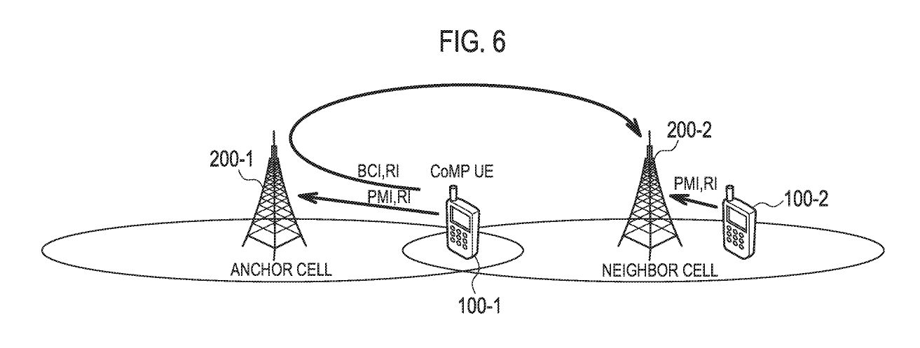

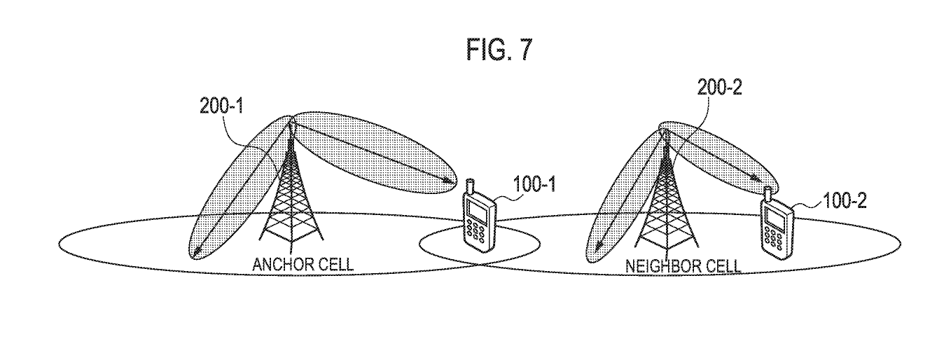

FIG. 6 and FIG. 7 are diagrams for describing the CB-CoMP. As shown in FIG. 6, an eNB 200-1 and an eNB 200-2 manage cells adjacent to each other. Further, the cell of the eNB 200-1 and the cell of the eNB 200-2 belong to the same frequency.

The UE 100-1 is in a state of establishing connection with a cell of the eNB 200-1 (connected state). That is, the UE 100-1 uses, as a serving cell, the cell of the eNB 200-1 to perform communication.

On the other hand, the UE 100-2 is in a state of establishing connection with a cell of the eNB 200-2 (connected state). That is, the UE 100-2 uses, as a serving cell, the cell of the eNB 200-2 to perform communication. In FIG. 6, only one UE 100-2 is shown which establishes the connection with the cell of the eNB 200-2; however, in a real environment, a plurality of UEs 100-2 establish the connection with the cell of the eNB 200-2.

The UE 100-1 is located at a boundary area of the cell of the eNB 200-1 and the cell of the eNB 200-2. In this case, the UE 100-1 is influenced by interference from the cell of the eNB 200-2. When the CB-CoMP is applied to the UE 100-1, it is possible to suppress the interference received in the UE 100-1.

A communication procedure of the CB-CoMP when the CB-CoMP is applied to the UE 100-1 will be described, below. It is noted that the UE 100-1 to which the CB-CoMP is applied may be called a “CoMP UE”. That is, the UE 100-1 corresponds to a terminal subject to null steering. The serving cell of the UE 100-1 (CoMP UE) may be called an “anchor cell”.

Each of the UE 100-1 and the UE 100-2 feeds beamforming control information for directing a beam to the UE 100-1 and the UE 100-2, back to the serving cell, on the basis of a reference signal received from the serving cell, for example. In the embodiment, the beamforming control information includes a precoder matrix indicator (PMI) and a rank indicator (RI). The PMI is an indicator indicating a precoder matrix (transmission antenna weight) recommended to the serving cell. The RI is an indicator indicating a rank (signal sequence number) recommended to the serving cell. Each of the UE 100-1 and the UE 100-2, which holds a table (code book) in which the precoder matrix and the indicator are associated, selects the precoder matrix that improves communication quality of a desired wave, and feeds back, as the PMI, the indicator corresponding to the selected precoder matrix.

The UE 100-1 further feeds null-steering control information for directing a null to the UE 100-1, back to the serving cell, on the basis of a reference signal received from a neighboring cell, for example. In the embodiment, the null-steering control information includes a BCI (Best Companion PMI) and the RI. The BCI is an indicator indicating a precoder matrix (transmission antenna weight) recommended to the neighboring cell. The UE 100-1, which holds a table (code book) in which the precoder matrix and the indicator are associated, selects the precoder matrix that reduces a reception level of an interference wave or reduces influence to a desired wave, and feeds back, as the BCI, the indicator corresponding to the selected precoder matrix.

The eNB 200-1 transfers the null-steering control information (BCI, RI) fed back from the UE 100-1, to the eNB 200-2.

The eNB 200-2 receives the beamforming control information (PMI, RI) fed back from each of the plurality of UEs 100-2 connected with a cell of the eNB 200-2 and the null-steering control information (BCI, RI) fed back from the UE 100-1 connected with the neighboring cell. Then, the eNB 200-2 selects the UE 100-2 that feeds back the beamforming control information that matches the null-steering control information, as a pair UE (pair terminal) that forms a pair with the UE 100-1. In the embodiment, the “beamforming control information that matches the null-steering control information” is beamforming control information that includes a combination of the PMI and the RI that matches a combination of the BCI and the RI included in the null-steering control information.

When selecting the pair UE (UE 100-2), the eNB 200-2 assigns the same radio resource as the radio resource assigned to the UE 100-1, to the pair UE. Then, the eNB 200-2 applies the beamforming control information (PMI, RI) fed back from the pair UE, and performs a transmission to the pair UE. As a result, as shown in FIG. 7, the eNB 200-2 is capable of performing a transmission to the pair UE by directing a beam to the pair UE while directing a null to the UE 100-1.

(Operation According to Embodiment)

(1) Operation Overview

As described above, the eNB 200-2 selects, as the pair UE that forms a pair with the UE 100-1, the UE 100-2 that feeds back the beamforming control information (PMI, RI) that matches the null-steering control information (BCI, RI) fed back from the UE 100-1. Here, the UE 100-1 corresponds to a terminal subject to null steering and the UE 100-2 corresponds to a terminal subject to beamforming.

However, when there is no UE 100-2 that feeds back the beamforming control information that matches the null-steering control information, the eNB 200-2 is not capable of selecting a pair UE that forms a pair with the UE 100-1. A communication control method for resolving such a problem will be described, below.

The communication control method according to the embodiment includes a step A of feeding back for a plurality of number of times, by the UE 100-1 subject to the null steering by the eNB 200-2, null-steering control information for controlling the null steering. “Feeding back for a plurality of number of times” is a periodic feedback, for example. However, in addition to the periodic feedback, an unperiodic feedback may also be possible.

Further, the communication control method according to the embodiment includes a step B of selecting, by the eNB 200-2, through a matching process in which the null-steering control information fed back from the UE 100-1 is checked with beamforming control information fed back from the UE 100-2, a pair UE that forms a pair with the UE 100-1 from among the UEs 100-2.

The eNB 200-2 manages a history of past null-steering control information fed back prior to the last time from the UE 100-1. In the step B, the eNB 200-2 applies, in addition to latest null-steering control information fed back this time from the UE 100-1, the past null-steering control information to the matching process.

Therefore, even when there is no UE 100-2 that feeds back the beamforming control information that matches the latest null-steering control information, it is possible to select the UE 100-2, as the pair UE, that feeds back the beamforming control information that matches the past null-steering control information. Thus, it is possible to apply the CB-CoMP to the UE 100-1.

In the embodiment, in the step B, the eNB 200-2 selects, as the pair UE, the UE 100-2 that feeds back the beamforming control information that matches either one of the latest null-steering control information or the past null-steering control information. The communication control method according to the embodiment further includes a step C of performing, by the eNB 200-2, a beamforming to the pair UE and a null steering to the UE 100-1, on the basis of the matched beamforming control information.

(2) Operation Specific Example

Next, as an operation specific example according to the embodiment, operation patterns 1 to 3 will be described.

(2.1) Operation Pattern 1

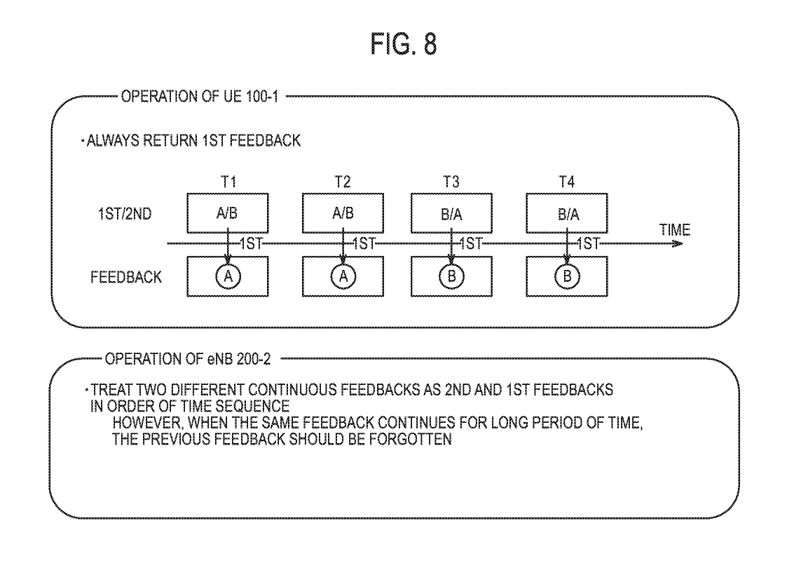

FIG. 8 is a diagram for explaining an operation pattern 1 according to the embodiment.

As shown in FIG. 8, in the operation pattern 1 according to embodiment, in the step A, the UE 100-1 feeds back null-steering control information having the highest priority order, from among a plurality of pieces of null-steering control information having a priority order set on the basis of a radio situation of the UE 100-1.

For example, for each of a plurality of PMIs (and RIs) included in a code book, the UE 100-1 sets the priority order for each combination of PMIs and RIs, by using, as an evaluation index, a degree by which a reception level of an interference wave is reduced or a degree by which an influence to a desired wave is reduced. Specifically, a highest priority order is set to a combination of PMI and RI having the highest degree by which the reception level of the interference wave is reduced or degree by which the influence to the desired wave is reduced. Then, the UE 100-1 feeds back the combination (null-steering control information) of the PMI and the RI having the highest priority order.

In an example of FIG. 8, at a time T1, the null-steering control information having the highest priority order is “A” and, the null-steering control information having the second highest priority order is “B”, and thus, the UE 100-1 feeds back “A”. After a time T2, the operation is performed according to a similar rule.

In the operation pattern 1 according to the embodiment, in the step B, the eNB 200-2 sets, as the priority order of the beamforming control information applied to the matching process, a relatively high priority order to beamforming control information that is relatively new.

In an example of FIG. 8, the eNB 200-2 treats the two consecutive different feedbacks as the second highest priority order and the highest priority order, in order of time sequence. For example, on the basis of the feedback at a time T3, the eNB 200-2 sets the highest priority order to “B” that is the latest null-steering control information, and sets the second highest priority order to

“A” that is the past feedback information corresponding to the time T2 (previous feedback). However, when the same feedback continues for a long period of time, the previous feedback may be ignored.

(2.2) Operation Pattern 2

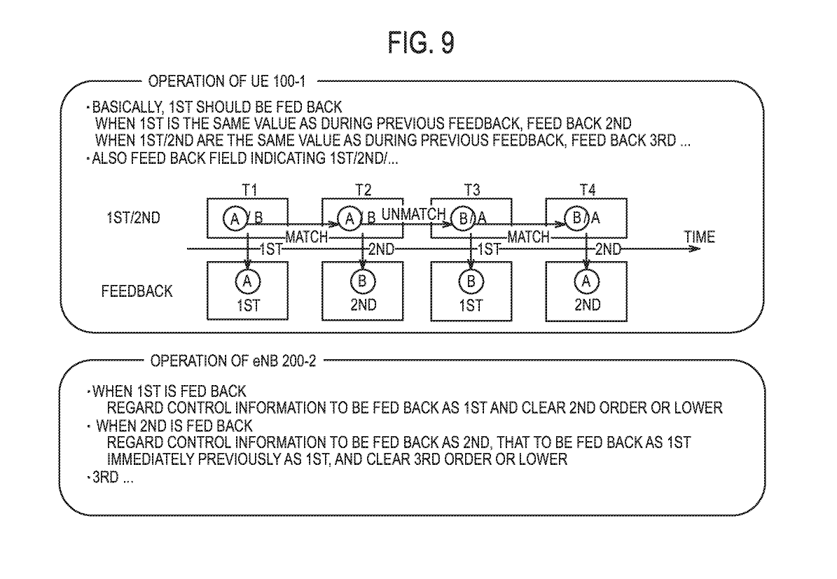

FIG. 9 is a diagram for describing an operation pattern 2 according to the embodiment. Here, description proceeds with a focus on a difference from the operation pattern 1.

As shown in FIG. 9, in the operation pattern 2 according to the embodiment, in the step A, when the null-steering control information having the highest priority order is different between during the last feedback and during the current feedback, the UE 100-1 feeds back the null-steering control information having the highest priority order. Further, when the null-steering control information having the highest priority order is the same between during the last feedback and during the current feedback, the UE 100-1 feeds back the null-steering control information having the second highest priority order. Further, when the null-steering control information having the highest priority order and the null-steering control information having the second highest priority order are the same between during the last feedback and during the current feedback, the UE 100-1 feeds back the null-steering control information having a third highest priority order. Thereafter, the operation is performed according to a similar rule.

In an example of FIG. 9, the null-steering control information having the highest priority order corresponding to the time T2 is “A” and the null-steering control information having the highest priority order corresponding to the time T1 that is the last feedback time is also “A”, and thus, the UE 100-1 feeds back, at the time T2, the null-steering control information “B” having the second highest priority order. Further, the null-steering control information having the highest priority order corresponding to the time T3 is “B” and the null-steering control information having the highest priority order corresponding to the time T2 that is the last feedback time is “A”, and thus, the UE 100-1 feeds back, at the time T3, the null-steering control information “B” having the highest priority order.

Thus, in the operation pattern 2 according to the embodiment, the UE 100-1 avoids overlapping of the last feedback and the current feedback, and preferentially feeds back the null-steering control information having a higher priority order.

Further, in the operation pattern 2 according to the embodiment, in the step A, the UE 100-1 adds additional information (field) associated with the priority order of the null-steering control information to be fed back, to the null-steering control information to be fed back. Specifically, the additional information is information indicating the priority order of the null-steering control information to be fed back. As a result, the eNB 200-2 is capable of grasping the priority order set to the null-steering control information to be fed back.

In the operation pattern 2 according to the embodiment, in the step B, when the latest null-steering control information is the null-steering control information having the highest priority order, the eNB 200-2 sets the latest null-steering control information to the highest priority order, as the priority order of the beamforming control information applied to the matching process, and deletes the history. Here, the reason why the history is deleted is explained as follows: The null-steering control information having the highest priority order is changed in the UE 100-1, which means that it is possible to consider that the radio environment in the UE 100-1 is changed. Therefore, the reliability of the history is low, and thus, the history is deleted.

In the operation pattern 2 according to the embodiment, in the step B, when the latest null-steering control information is the null-steering control information having the second highest priority order, the eNB 200-2 sets, as the priority order of the beamforming control information applied to the matching process, the past null-steering control information having the newest highest priority order of the history, to the highest priority order, sets the latest null-steering control information to the second highest priority order, and deletes the past null-steering control information having a second highest order or lower included in the history. Thereafter, the operation is performed according to a similar rule.

Alternatively, the operation in which the history is deleted in the eNB 200-2 may be changed to an operation as follows: In the step B, when the latest null-steering control information is the null-steering control information having the highest priority order, as the priority order of the beamforming control information applied to the matching process, the eNB 200-2 sets the latest null-steering control information to the highest priority order and moves down by one the priority order of the past null-steering control information included in the history. In this case, the history is not deleted, and thus, it is possible to effectively utilize the history.

Further, in the step B, when the latest null-steering control information is the null-steering control information having the second highest priority order, as the priority order of the beamforming control information applied to the matching process, the eNB 200-2 sets the past null-steering control information having the newest highest priority order of the history to the highest priority order, sets the latest null-steering control information to the second highest priority order, and moves down by one the priority order of the second highest priority order or lower of the past null-steering control information included in the history.

(2.3) Operation Pattern 3

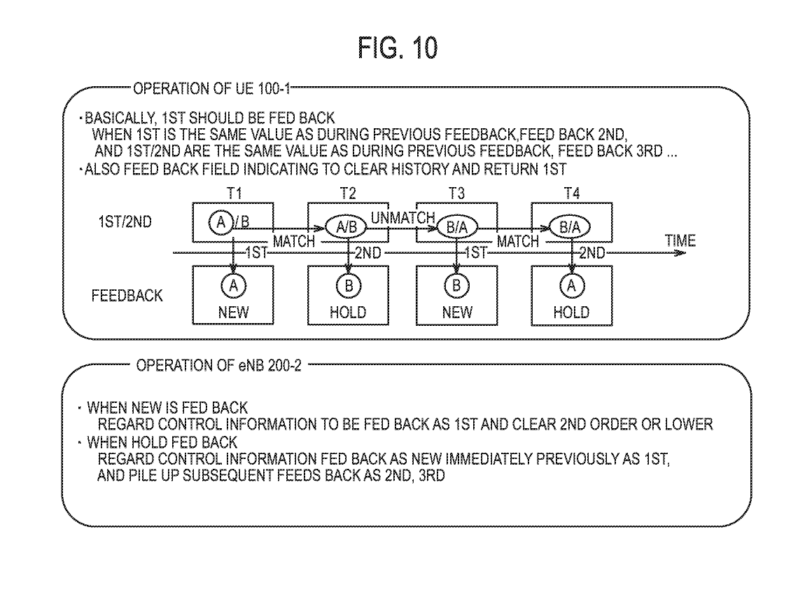

FIG. 10 is a diagram for describing an operation pattern 3 according to the embodiment. The operation pattern 3 resembles the operation pattern 2 in operation, and thus, description proceeds with a focus on a difference from the operation pattern 2.

As shown in FIG. 10, in the operation pattern 3 according to the embodiment, the method of selecting the null-steering control information fed back in the UE 100-1 is similar to that of the operation pattern 2.

However, in the operation pattern 3 according to the embodiment, additional information added to the null-steering control information to be fed back is that is information indicating whether or not the history managed by the eNB 200-2 should be deleted. When feeding back the null-steering control information having the highest priority order, the UE 100-1 adds, as additional information, information (new) indicating that the history should be deleted, to the null-steering control information. Further, when feeding back the second null-steering control information or lower, the UE 100-1 adds, as the additional information, information (hold) indicating that the history should not be deleted, to the null-steering control information.

In the operation pattern 3 according to the embodiment, in the step B, when it is indicated that the history should be deleted, as the priority order of the beamforming control information applied to the matching process, the eNB 200-2 sets the latest null-steering control information to the highest priority order, and deletes the history.

Further, in the operation pattern 3 according to the embodiment, in the step B, when it is indicated that the history should not be deleted, as the priority order of the beamforming control information applied to the matching process, the eNB 200-2 sets the past null-steering control information having the newest highest priority order of the history, to the highest priority order, and sets the past null-steering control information fed back subsequent to the past null-steering control information having the newest highest priority order, to the second highest priority order.

Thus, in the operation pattern 3 according to the embodiment, the additional information has only two types that are new and hold, and thus, as compared to the operation pattern 2, it is possible to reduce an information amount of the additional information.

[Modification]

In the above-described embodiment, an example is described where the present invention is applied to the CB-CoMP which is a mode of the downlink multi-antenna transmission; however, the present invention may be applied to MU (Multi-User)-MIMO (Multiple-Input And Multiple-Output) which is another mode of the downlink multi-antenna transmission. In a modification of the embodiment, a case will be described where the present invention is applied to the MU-MIMO.

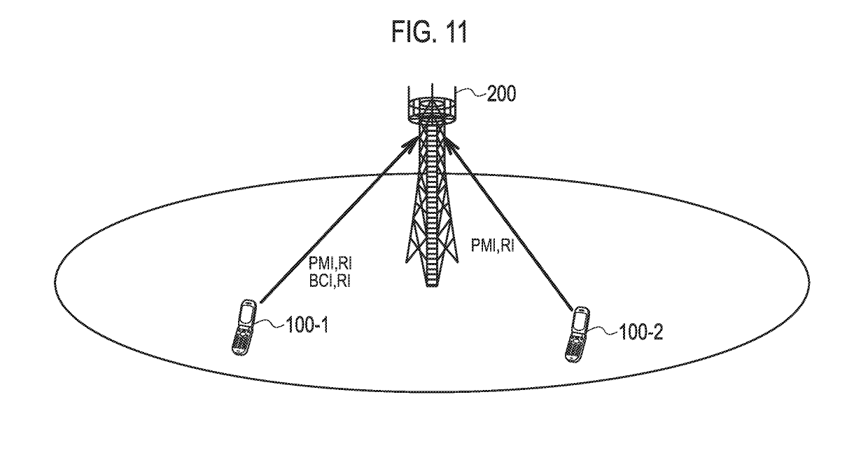

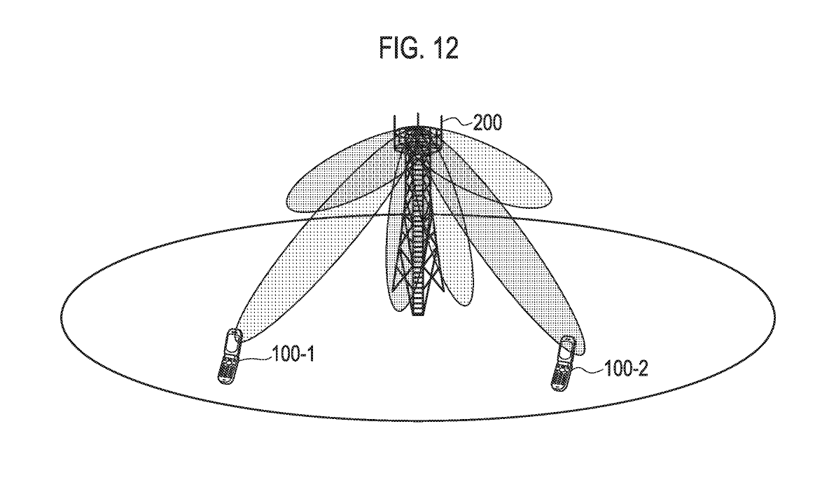

FIG. 11 and FIG. 12 are diagrams for describing the MU-MIMO. As shown in FIG. 11, each of the UE 100-1 and the UE 100-2 is in a state of establishing connection with a cell of the eNB 200 (connected state). That is, each of the UE 100-1 and the UE 100-2 uses, as a serving cell, the cell of the eNB 200 to perform communication. In FIG. 11, only two UEs 100 are shown which establish the connection with the cell of the eNB 200; however, in a real environment, three or more UEs 100 establish the connection with the cell of the eNB 200.

A communication procedure of the MU-MIMO when the MU-MIMO is applied to the UE 100-1 will be described, below. Here, the UE 100-1 corresponds to a terminal subject to null steering and the UE 100-2 corresponds to a terminal subject to beamforming. It is noted that a description duplicated with the above-described embodiment will be omitted.

Each of the UE 100-1 and the UE 100-2 feeds beamforming control information for directing a beam to the UE 100-1 and the UE 100-2, back to the serving cell, on the basis of a reference signal received from the serving cell, for example. The beamforming control information includes the PMI and the RI.

The UE 100-1 further feeds null-steering control information for directing a null to the UE 100-1, back to the serving cell, on the basis of a reference signal received from the serving cell, for example. The null-steering control information includes a BCI (Best Companion PMI) and an RI.

The eNB 200 receives the beamforming control information (PMI, RI) fed back from each of the plurality of UEs 100-2 connected with a cell of the eNB 200 and the null-steering control information (BCI, RI) fed back from the UE 100-1 connected with a cell of the eNB 200. Then, the eNB 200 selects the UE 100-2 that feeds back the beamforming control information that matches the null-steering control information, as a pair UE (pair UE) that forms a pair with the UE 100-1.

When selecting the pair UE (UE 100-2), the eNB 200 assigns the same radio resource as the radio resource assigned to the UE 100-1, to the pair UE. Then, the eNB 200 applies the beamforming control information (PMI, RI) fed back from the pair UE, and performs a transmission to the pair UE. As a result, as shown in FIG. 12, the eNB 200 is capable of performing a transmission to the pair UE by directing a beam to the pair UE while directing a null to the UE 100-1.

In the present modification, in the communication control method according to the above-described embodiment, when the eNB 200-1 and the eNB 200-2 are regarded as one eNB 200, it is possible to appropriately select the pair UE to forma a pair with the UE 100-1, even in the MU-MIMO.

### Other Embodiments

In the above-described embodiment, the null-steering control information transmitted by the UE 100-1 is indirectly fed back to the eNB 200-2 via the eNB 200-1; however, the null-steering control information may be directly fed back to the eNB 200-2 without passing through the eNB 200-1.

In the above-described embodiment and modification thereof, the BCI is described as an example of the null-steering control information; however, a WCI (Worst Companion PMI) may be used instead of the BCI. The WCI is an indicator indicating the precoder matrix in which an interference level from an interference source is high. The eNB 200 receives the beamforming control information (PMI, RI) fed back from each of the plurality of UEs 100-2 and the null-steering control information (WCI, RI) fed back from the UE 100-1. Then, the eNB 200 selects the UE 100-2 that feeds back the beamforming control information that matches the null-steering control information, as a pair UE (pair terminal) that forms a pair with the UE 100-1. In this case, the “beamforming control information that matches the null-steering control information” is beamforming control information that includes the PMI that does not match the WCI included in the null-steering control information, or that includes the RI that matches the RI included in the null steering control information.

In the above-described embodiments, as one example of cellular communication system, the LTE system is described; however, the present invention is not limited to the LTE system, and the present invention may be applied to systems other than the LTE system.

It is noted that the entire content of Japanese Patent Application No. 2013-199876 (filed on Sep. 26, 2013) is incorporated in the present application by reference.

### INDUSTRIAL APPLICABILITY

Thus, according the present invention, it is possible to provide a communication control method, a base station, and a user terminal, with which it is possible to effectively utilize downlink multi-antenna transmission.

1. A communication control method used in a mobile communication system that supports downlink multi-antenna transmission, comprising:
a step A of feeding back for a plurality of number of times, by a user terminal subject to null steering by a base station, null-steering control information for controlling the null steering; and
a step B of selecting, by the base station, through a matching process in which the null-steering control information fed back from the user terminal is checked with beamforming control information fed back from other user terminals, a pair terminal that forms a pair with the user terminal from among the other user terminals, wherein
the base station manages a history of past null-steering control information fed back prior to a last time from the user terminal, and
in the step B, the base station applies, in addition to latest null-steering control information fed back this time from the user terminal, the past null-steering control information to the matching process.

2. The communication control method according to claim 1, wherein in the step B, the base station selects, as the pair terminal, the one of the other user terminals that feeds back the beamforming control information that matches either one of the latest null-steering control information or the past null-steering control information, and
the communication control method further comprises a step C of performing, by the base station, a beamforming to the pair terminal and the null steering to the user terminal, on the basis of the matched beamforming control information.

3. The communication control method according to claim 1, wherein in the step A, the user terminal feeds back null-steering control information having a highest priority order, from among a plurality of pieces of null-steering control information having a priority order set on the basis of a radio situation of the user terminal, and
in the step B, the base station sets, as a priority order of the beamforming control information applied to the matching process, a relatively high priority order to the beamforming control information that is relatively new.

4. The communication control method according to claim 1, wherein in the step A, the user terminal:
derives a plurality of pieces of null-steering control information having a priority order set on the basis of a radio situation of the user terminal,
when the null-steering control information having a highest priority order is different between during a last feedback and during a current feedback, feeds back the null-steering control information having the highest priority order, and
when the null-steering control information having the highest priority order is the same between during the last feedback and during the current feedback, feeds back null-steering control information having a second highest priority order.

5. The communication control method according to claim 4, in the step A, when the null-steering control information having the highest priority order and the null-steering control information having the second highest priority order are the same between during the last feedback and during the current feedback, the user terminal feeds back null-steering control information having a third highest priority order.

6. The communication control method according to claim 4, in the step A, the user terminal adds additional information associated with the priority order of null-steering control information to be fed back, to the null-steering control information to be fed back.

7. The communication control method according to claim 6, wherein the additional information is information indicating the priority order of the null-steering control information to be fed back.

8. The communication control method according to claim 6, wherein the additional information is information indicating whether or not the history managed by the base station should be deleted.

9. The communication control method according to claim 4, in the step B, when the latest null-steering control information is the null-steering control information having the highest priority order or when it is indicated that the history should be deleted, as the priority order of the beamforming control information applied to the matching process, the base station sets the latest null-steering control information to the highest priority order, and deletes the history.

10. The communication control method according to claim 4, wherein in the step B, when the latest null-steering control information is the null-steering control information having the highest priority order, as the priority order of the beamforming control information applied to the matching process, the base station sets the latest null-steering control information to the highest priority order and moves down by one the priority order of the past null-steering control information included in the history.

11. The communication control method according to claim 7, in the step B, when the latest null-steering control information is the null-steering control information having the second highest priority order, as the priority order of the beamforming control information applied to the matching process, the base station sets the past null-steering control information having the newest highest priority order of the history, to the highest priority order, sets the latest null-steering control information to the second highest priority order, and deletes the past null-steering control information having a second priority order or lower included in the history.

12. The communication control method according to claim 7, in the step B, when the latest null-steering control information is the null-steering control information having the second highest priority order, as the priority order of the beamforming control information applied to the matching process, the base station sets the past null-steering control information having the newest highest priority order of the history, to the highest priority order, sets the latest null-steering control information to the second highest priority order, and moves down by one the priority order of the past null-steering control information having a second priority order or lower included in the history.

13. The communication control method according to claim 8, wherein in the step B, when it is indicated that the history should not be deleted, as the priority order of the beamforming control information applied to the matching process, the base station sets the past null-steering control information having the newest highest priority order of the history, to the highest priority order, and sets the past null-steering control information fed back subsequent to the past null-steering control information having the newest highest priority order, to the second highest priority order.

14. A base station used in a mobile communication system that supports downlink multi-antenna transmission, comprising:
a receiver configured to receive null-steering control information fed back for a plurality of number of times from a user terminal subject to null steering by the base station; and
a controller configured to select, through a matching process in which the null-steering control information fed back from the user terminal is checked with beamforming control information fed back from other user terminals, a pair terminal that forms a pair with the user terminal from among the other user terminals, wherein
the controller manages a history of past null-steering control information fed back prior to a last time from the user terminal, and
the controller applies, in addition to latest null-steering control information fed back this time from the user terminal, the past null-steering control information to the matching process.

15. A user terminal subject to null steering by a base station, in a mobile communication system that supports downlink multi-antenna transmission, comprising:
a controller configured to feed back for a plurality of number of times null-steering control information for controlling the null steering, wherein
the controller adds additional information associated with the priority order of the null-steering control information to be fed back, to the null-steering control information to be fed back.
